(19) United States
(12) Patent Application Publication
(10) Pub. No.: US 2005/0147146 A1
(43) Pub. Date: Jul. 7, 2005

(54) Dual-laser coupling device

(76) Inventor: Ching-Sung Lin, TaoYuan (TW)

Correspondence Address: BRUCE H. TROXELL, SUITE 1404, 5205 LEESBURG PIKE, FALLS CHURCH, VA, 22041, US

(21) Appl. No.: 10/751,924

(22) Filed: Jan. 7, 2004

(51) Int. Cl. H01S 3/14; H01S 3/082; H01S 3/08

(52) U.S. Cl. 372/68; 372/97

(57) ABSTRACT

The present invention relates to a dual-laser coupling device, which comprises: a body, a first laser mount, a mirror, a second laser mount, and a filter. The first laser mount is set on the body and is capable of mounting a first laser. The mirror is set on the body and arranged on the optical path of the first laser, which is capable of reflecting the first laser beam. The second laser mount is set on the body parallel to the first laser mount and is capable of mounting a second laser. The filter is set on the body and arranged on the optical path of the second laser allowing the second laser beam to pass through while reflecting the first laser beam. The first laser beam is reflected to the filter by the mirror, wherein the first and the second laser beams are overlapped in order to achieve the effect of color mixing.

### BACKGROUND OF THE INVENTION

1. Field of the Invention

The present invention relates to a dual-laser coupling device, and more particularly, to a dual laser coupling device capable of overlapping two laser beams of different colors for color mixing.

2. Description of the Prior Art

A conventional laser emits only monochromatic light. Unlike the light produced by a regular light source that will disperse after passing through a prism, the laser beam stays collimated because it is a monochromatic light. The common colors of the laser beams include red, green, and blue, and all of which have a very good collimation property. The light from a conventional flash light, when pointing toward a distant place in the night, diverges into a cone shape and cannot travel far. On the other hand, when pointing a laser beam at an object 30 or 40 meters away, a red dot illuminated by the laser beam can still be seen clearly on the surface of the object, moreover, when pointing the laser beam toward the sky, the beam will remain collimated even after propagating a very long distance. Since the laser beam remains collimated without diverging into a cone shape, the energy of the beam is very concentrated that some high energy laser beams can be used to cut objects. The applications of laser beam are extensive. For example, in the industry, a high energy laser beam can be used for drilling, cutting, and soldiering, etc. It can also be used for medical or entertaining applications, such as reading out the music or data in a disc by using a laser head in a CD player, a CD-ROM, or a DVD player. In addition, events such as an outdoor party also use laser beams to enhance the visual effects by projecting them onto the sky. However, it seems somehow boring since the laser beam is a monochromatic light that the color cannot be changed. Therefore, the object of the present invention is to provide a dual-laser coupling device that is capable of mixing two laser beams of different colors and varying the tint by controlling the relative intensities of the two beams.

### SUMMARY OF THE INVENTION

The primary object of the present invention is to provide a dual-laser coupling device capable of mixing two laser beams of different colors.

Another object of the present invention is to provide different effects in color mixing by varying the relative intensities of the two laser beams.

The dual-laser coupling device of the present invention comprises: a body, a first laser mount, a mirror, a second laser mount, a filter, and a control circuit. The first laser mount is set on the body for mounting a first laser. The mirror is mounted on an adjustable base set on the body and arranged on the optical path of the first laser to reflect the first laser beam. By adjusting the adjustable base, the position of the mirror can be adjusted. The second laser mount is set on the body parallel to the first laser mount for mounting a second laser. The filter is set on the body and arranged on the optical path of the second laser, which allows the second laser beam to pass through while reflects the first laser beam. Wherein, The first laser beam is reflected to the filter precisely by the mirror, such that the first and the second laser beams are overlapped in order to achieve the effect of color mixing.

In another preferred embodiment, the dual-laser coupling device of the present invention comprises: a body, a first laser mount, a mirror, a second mirror mount, a filter, and a control circuit. The first laser mount is set on the body for mounting a first laser. The mirror is mounted on an adjustable base set on the body and arranged on the optical path of the first laser to reflect the first laser beam. By adjusting the adjustable base, the position of the mirror can be adjusted. The second laser mount is set on the body parallel to the first laser mount for mounting a second laser. The filter is set on the body and arranged on the optical path of the second laser, which allows the first laser beam to pass through while reflects the second laser beam. Wherein, the first laser beam is reflected to the filter precisely by the mirror, such that the first and the second laser beams are overlapped in order to achieve the effect of color mixing.

To further describe the features, objects and functions of the present invention, drawings and detailed description of the preferred embodiment are presented as follows:

### BRIEF DESCRIPTION OF THE DRAWINGS

FIG. 1 is a 3-D drawing of a dual-laser coupling device depicting a preferred embodiment of the present invention.

FIG. 2 is a schematic drawing of a dual-laser coupling device depicting a preferred embodiment of the present invention.

FIG. 3 is a schematic drawing of a dual-laser coupling device depicting another preferred embodiment of the present invention.

FIG. 4 is a schematic drawing of a dual-laser coupling device depicting yet another preferred embodiment of the present invention

### DETAILED DESCRIPTION OF THE PREFERRED EMBODIMENT

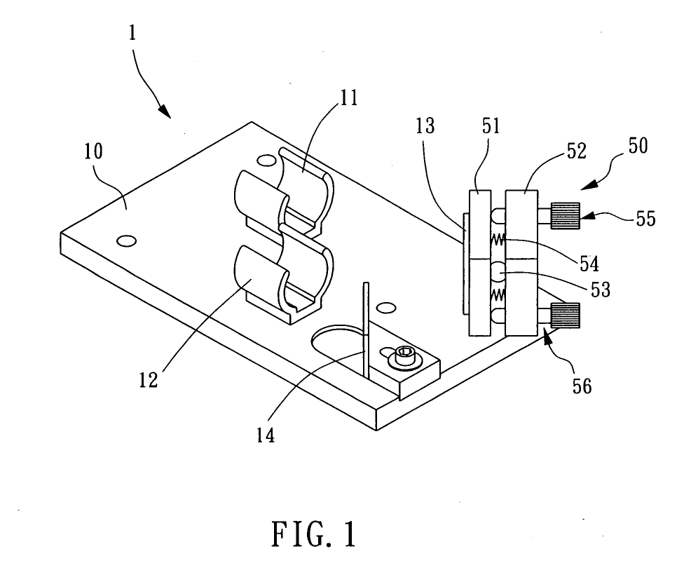

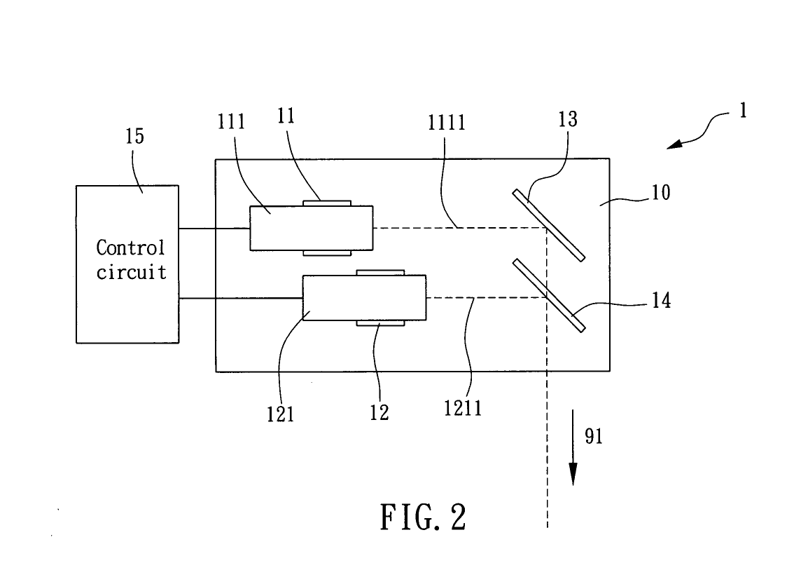

Please refer to FIG. 1 and FIG. 2, which are a 3-D and a schematic drawings of a dual-laser coupling device depicting a preferred embodiment of the present invention, respectively. The dual-laser coupling device 1 comprises: a body 10, a first laser mount 11, a mirror 13, a second laser mount 12, a filter 14, and a control circuit 15. The first laser mount 11 is set on the body 10 and is capable of mounting a first laser 111. The mirror 13 is mounted on an adjustable base 50 set on the body 10 and arranged on the optical path of the first laser 111 to reflect the light of the first laser 111. Moreover, by adjusting the adjustable base 50, the incident position of the light of the first laser 111 (which is called the first laser beam 1111, hereinafter) to the mirror 13 can be adjusted. The second laser mount 12 is set on the body 10 parallel to the first laser mount 11 and is capable of mounting a second laser 121. The filter 14, set on the body 10 and arranged on the optical path of the second laser 121, is evaporation-coated with a thin film. The coating of the filter 14 allows the first laser beam 1111 to pass through and reflects the light of the second laser 121 (which is called the second laser beam 1211, hereinafter). Depending on the demands, the laser beam with a certain wavelength can either pass through or get reflected by the filter by choosing different kinds of coatings. The control circuit 15 is adapted for controlling the light intensities of the first laser 111 and the second laser 121. In the present preferred embodiment, the first laser 111 and the second laser 121 are chosen to have different colors and different optical spectra.

As the dual-laser coupling device 1 of the present invention is in operation, the mirror 13 arranged on the optical path of the first laser 111 will reflect the first laser beam 1111 to the filter 14, and the first laser beam will pass through the filter 14 and propagate along a first direction 91. Arranged on the optical path of the second laser beam 1211, the filter 14 will also reflect the second laser beam 1211 to the first direction 91. By adjusting the position of the mirror 13, the first and the second laser beams can be overlapped along the first direction 91 to achieve the effect of color mixing of two laser beams. Besides, since the control circuit 15 is capable of controlling the intensities of the first and the second laser beams, the color of the mixture of the first and second laser beams can be varied according to the relative light intensities of the first laser 111 and the second laser 121.

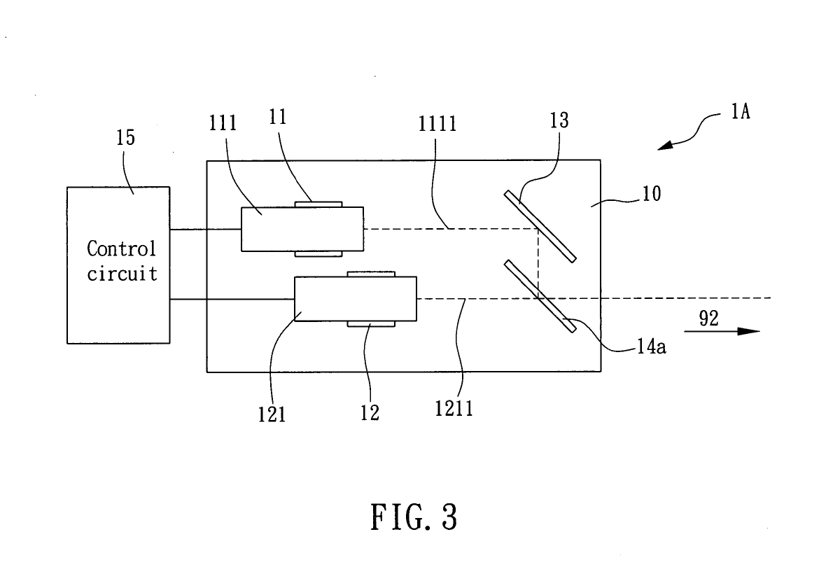

Please refer to FIG. 3, which is a schematic drawing of a dual-laser coupling device depicting another preferred embodiment of the present invention. In the present embodiment, the coating of the filter 14a is chosen so that the second laser beam 1211 can pass through while the first laser beam 1111 will get reflected.

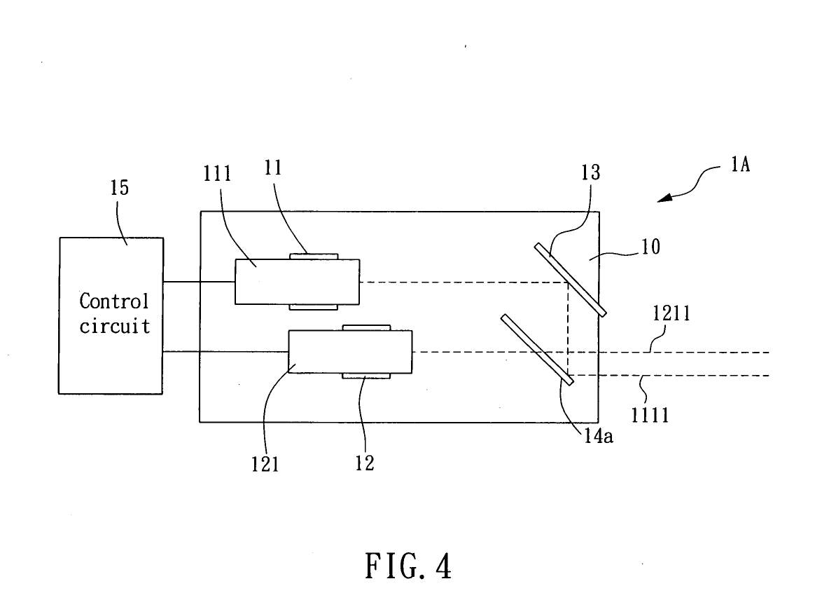

As the dual-laser coupling device 1A of the present invention is in operation, the mirror 13 arranged on the optical path of the first laser 111 will reflect the first laser beam 1111 to the filter 14a, and the filter will reflect the first laser beam to a second direction 92. Arranged on the optical path of the second laser beam 1211, the filter 14a will allow the second laser beam 1211 to pass through and also propagate along the second direction 92. By adjusting the position of the mirror 13, the first and the second laser beams can be overlapped along the second direction 92 to achieve the effect of color mixing of two laser beams. Moreover, by controlling the relative intensities of the two laser beams with the control circuit 15, beams with various colors can be obtained. Besides, by adjusting the position of the mirror 13 (as shown in FIG. 4), the incident position of the first laser beam 1111 can be adjusted so that there is a proper separation between the first laser beam 1111 and the second laser beam 1211 to form a dual-beam effect.

In addition, showing in FIG. 1 is a 3-D diagram of an adjustable base depicting a preferred embodiment of the present invention. The mirror mount 50 has a first plate 51 and a second plate 52, wherein the mirror 13 is mounted on the first plate 51. Between the first plate 51 and the second plate 52, there is a connecting point and a plurality of springs 54 that connect the plates together. A first rotary column 55 and a second rotary column 56 are set on the second plate 52 to hold the first plate away from the second plate. By rotating the first rotary column 55 and the second rotary column 56, the separation and angle between the first plate 51 and the second plate 52 can be adjusted so that the incident position of the first laser beam 1111 to the mirror 13 can be adjusted accordingly and the effect of either overlapping or separating the two beams can be achieved.

While the present invention has been described in connection with what is considered the most practical and preferred embodiment, it is understood that the invention is not limited to the disclosed embodiments but is intended to cover various arrangements included within the spirit and scope of the broadest interpretation and equivalent arrangements.

1. A dual-laser coupling device, comprising:
a body;
a first laser mount, set on said body and capable of mounting a first laser;
a mirror, mounted on an adjustable base set on said body and arranged on the optical path of said first laser to reflect the light of said first laser, wherein the position of said mirror can be adjusted by adjusting said adjustable base;
a second laser mount, set on said body parallel to said first laser mount, capable of mounting a second laser; and
a filter, set on said body and arranged on the optical path of said second laser, capable of allowing the light of said second laser to pass through while reflecting the light of said first laser;
wherein, the light of said first laser can be reflected precisely to said filter.

2. The dual-laser coupling device of claim 1, wherein the beams of said first laser and said second laser is overlapped.

3. The dual-laser coupling device of claim 1, wherein the beams of said first laser and said second laser are separated by a predefined distance.

4. The dual-laser coupling device of claim 1, wherein said first and said second lasers are of different laser sources.

5. The dual-laser coupling device of claim 1, wherein said dual-laser coupling device further comprises: a control circuit, capable of controlling the intensities of said first and said second lasers.

6. The dual-laser coupling device of claim 1, wherein said filter has a film coating by the vapor deposition.

7. The dual-laser coupling device of claim 1, wherein said adjustable base has a first plate and a second plate, and between said first plate and said second plate, a plurality of springs and a connecting point are arranged for connecting the two plates, and on said second plate, two rotary columns are set to hold said first plate away from said second plate and are capable of adjusting the distance and angle between said first plate and said second plate.

8. A dual-laser coupling device, comprising:
a body;
a first laser mount, set on said body and capable of mounting a first laser;
a mirror, mounted on an adjustable base set on said body and arranged on the optical path of said first laser to reflect the light of said first laser, which the position of it can be adjusted by adjusting said adjustable base;
a second laser mount, set on said body parallel to said first laser mount, capable of mounting a second laser; and
a filter, set on said body and arranged on the optical path of said second laser, capable of reflecting the light of said second laser;
wherein, the light of said first laser can be reflected precisely to said filter and said filter will allow the light of said first laser to pass through.

9. The dual-laser coupling device of claim 8, wherein the beams of said first laser and said second laser is overlapped.

10. The dual-laser coupling device of claim 8, wherein the beams of said first laser and said second laser are separated by a predefined distance.

11. The dual-laser coupling device of claim 8, wherein said first and said second lasers are of different laser light sources.

12. The dual-laser coupling device of claim 8, wherein said dual-laser coupling device further comprises: a control circuit, capable of controlling the intensities of said first and said second lasers.

13. The dual-laser coupling device of claim 8, wherein said filter has a film coating by the vapor deposition.

14. The dual-laser coupling device of claim 8, wherein said adjustable base has a first plate and a second plate, and between said first plate and said second plate, a plurality of springs and a connecting point are arranged for connecting the two plates, and on said second plate, two rotary columns are set to hold said first plate away from said second plate and are capable of adjusting the distance and angle between said first plate and said second plate.
